(19) United States
(12) Patent Application Publication
(10) Pub. No.: US 2012/0308973 A1
(43) Pub. Date: Dec. 6, 2012

(54) KIT AND METHOD FOR PROMOTION OF POSITIVE ADJUSTMENT TO ILLNESS AND TRAUMA

(75) Inventors: Meghan L. Marsac, Philadelphia, PA (US); Anne Marie Vinsel, Salt Lake City, UT (US)

(73) Assignee: THE CHILDREN'S HOSPITAL OF PHILADELPHIA, Philadelphia, PA (US)

(21) Appl. No.: 13/576,894

(22) PCT Filed: Jan. 31, 2011
(86) PCT No.: PCT/US11/23162

§ 371 Date: Aug. 2, 2012

Related U.S. Application Data
(60) Provisional application No. 61/301,769, filed on Feb. 5, 2010.

(51) Int. Cl. G09B 19/00

(52) U.S. Cl. 434/236

(57) ABSTRACT

A kit for use in promoting a patient's positive adjustment includes a plurality of module units, each module unit containing instructions for coping with a specific stress symptom, and a transitional object having a module unit receiver. The module unit receiver can receive one of the module units and deliver the instructions on the module unit to the patient. A method of promoting positive adjustment includes the steps of providing a patient with a transitional object and a plurality of module units, each module unit containing instructions for coping with a specific stress symptom, identifying a stress symptom, selecting a module unit having instructions for coping with the stress symptom and delivering the instructions on the selected module unit to the patient with the transitional object.

### FIELD OF THE INVENTION

The present invention relates generally to tools and methods for assisting patients with illness and trauma, and more specifically to a kit and method for promoting positive adjustment to stressors caused by illness and trauma.

### BACKGROUND

Events related to injury, medical illness, and medical treatment are among the most common traumatic experiences of children, but the emotional impact of these events is under-recognized and under-treated. Psychosocial sequelae play an important role in determining how well children recover. A child who is diagnosed with a serious disease, incurs a potentially traumatic injury or who witnesses a traumatic event can suffer from various forms of stress (e.g., posttraumatic stress, anxiety, depression). Parents, siblings, relatives and close friends of the child can also suffer from various forms of stress in response to the child's illness or experience. Tools to promote positive adjustment can prevent stress symptoms from becoming overwhelming for children and their families.

Although professional mental health services can be very effective for dealing with stressful experiences (and are necessary if a child or family member has clinically significant, impairing symptoms), services are not typically available to be utilized as prevention tools (i.e., before the child or his or her family members have significant, impairing psychological symptoms). Thus, while patients undergoing long-term medical treatments or chronic medical problems face continued stressors, they are often left without ideas about how to deal with the stress they experience. Children and adults often experience anxiety in anticipation of medical appointments or procedures. In addition, children and adults can suffer physical side effects from the medical treatments (e.g., nausea, difficulties sleeping), creating additional stresses. These experiences can create daily stress symptoms such as body symptoms (e.g., nausea, pain) or psychological symptoms (e.g., frequent worries, avoidance of medical appointments/medications). In most cases, it is not feasible or practical for a professional counselor to assist the patient and his or her family throughout each medical appointment or procedure or each time they become worried about their diagnosis or treatment. As reported by the United States Public Health Service, “children and families are suffering because of missed opportunities for prevention and early identification, fragmented services, and low priorities for resources.” As a result, the child and his or her family must find other ways of coping with stress symptoms, or else suffer through them.

Applicants surveyed a number of parents of children with cancer to assess how well hospitals provide emotional support services to children with cancer. Parents of children treated at a number of different hospitals were specifically questioned about the level of support that their child received during cancer treatment and the resources that they found to help their child cope. Eighty percent of the respondents indicated that their child was not prepared for the stressors caused by cancer (e.g., diagnosis, chemotherapy, blood draws/IVs, feeling sick from treatment, taking medications). Parents also reported few resources that addressed the emotional aspects of cancer. Although hospitals have many trained doctors, nurses and staff members available to speak with children and their caregivers, there still exists a need for a mechanism that prepares children to prepare for stressors before they are experienced, and to cope with those stressors on a daily basis.

### SUMMARY

Applicants have developed a kit and a method for coping with stressors associated with serious illnesses, traumatic injuries, and other stressful experiences. The kit and methodology can be used, for example, as a tool for promoting positive adjustment to the diagnosis and treatment of serious illnesses in children and their families. The kit and the methodology utilize developmentally appropriate aids for children that can be adapted for specific stressors. The aids may be provided in the form of module units, each module unit designed to address a specific stressor. The term “module unit” as used herein refers to an object or medium that carries a specific instruction for how to address a stressor. Module units in accordance with the invention may include, but are not limited to, printed media such as cards. Alternatively, module units in accordance with the invention may include electronic storage media, such as memory sticks, cartridges and discs.

Module units are conveyed to the patient through a transitional object. The term “transitional object” as used herein means any object that is used by a patient in seeking reassurance, comfort, companionship, security, confidence, independence or emotional support in coping with stressors. Examples of transitional objects include but are not limited to toys, dolls, stuffed animals or blankets, and may take on identities in the form of companions in the mind of the patient. In addition to comforting patients, transitional objects function as a communication link for patients, particularly younger children, who may have trouble communicating with their doctors, nurses, therapists or other caregivers.

Transitional objects in accordance with the invention have one or more module unit receivers. The term “module unit receiver” as used herein means any feature or location in, on or associated with the transitional object that receives or is activated by a module unit. The module unit receiver may receive a module unit in a variety of ways, including but not limited to physical placement of the module unit inside the module unit receiver or plugging the module unit into the module unit receiver. In the latter example, plugging the module unit into the module unit receiver may be followed by a data transmission from a transmitter on the module unit to a receiver in the module unit receiver. Thus, the module unit receiver may be a cavity or space in or on the transitional object, or may be a receiver device or slot operable to receive data from a electronic storage medium.

The following description and drawing figures will describe aspects of a kit and method that are specifically developed for use with children diagnosed with cancer, and for family members, friends and caregivers who assist the child, or need assistance in coping with the child's diagnosis and treatment. It will be understood that the present invention can be adapted and used by children and adults suffering from many stressful experiences, and usage of the invention is not intended solely for illnesses such as cancer.

### BRIEF DESCRIPTION OF THE DRAWING FIGURES

With regard to the drawing figures,

FIG. 1 is a perspective view of a kit shown in accordance with one exemplary embodiment of the invention; and

FIG. 2 is a perspective view of a kit shown in accordance with another exemplary embodiment of the invention.

### DETAILED DESCRIPTION

In one embodiment, a kit for use in promoting a patient's positive adjustment includes a plurality of module units, each module unit containing an instruction for coping with a specific stress symptom. The kit also includes a transitional object having a module unit receiver for receiving one of the module units and delivering the instruction on the module unit to the patient.

The plurality of module units may include a plurality of cards with printed indicia, and the module unit receiver may be in the form of a cavity inside the transitional object adapted to physically store one or more of the cards.

Alternatively, or in addition, the plurality of module units may include a plurality of electronic storage media, each electronic storage medium comprising a transmitter for transmitting an instruction to the module unit receiver, the module unit receiver comprising a receiving device for reading the instruction transmitted by the electronic storage medium.

The plurality of electronic storage media may include a plurality of cartridges, and the receiving device may include a cartridge slot.

The transitional object may include a digital audio playback device. In addition, the transitional object may include an electronic user interface and display screen.

The kit may additionally include a coping tool, which may be sized to be stored inside the transitional object.

In another embodiment, a method of promoting positive adjustment includes the step of providing a patient with a transitional object and a plurality of module units, each module unit containing an instruction for coping with a specific stress symptom, identifying a stress symptom that is experienced by the patient, selecting a module unit having an instruction for coping with the identified stress symptom, inserting the selected module unit in the transitional object, and delivering the instruction on the selected module unit to the patient with the transitional object.

The method may include the step of physically placing the module unit inside a cavity in the transitional object.

Alternatively, the method may include the step of inserting an electronic storage medium into a slot in the transitional object.

Each module unit may be in the form of a card. The step of delivering the instructions on the selected module unit to the patient may include giving the transitional object with the card to the patient.

As an alternative, the step of delivering the instruction on the selected module unit to the patient may include inserting an electronic storage medium into the transitional object and playing back an audio recording.

The method may further include the step of selecting a module unit having an instruction for a caregiver for helping the patient cope with a stress symptom.

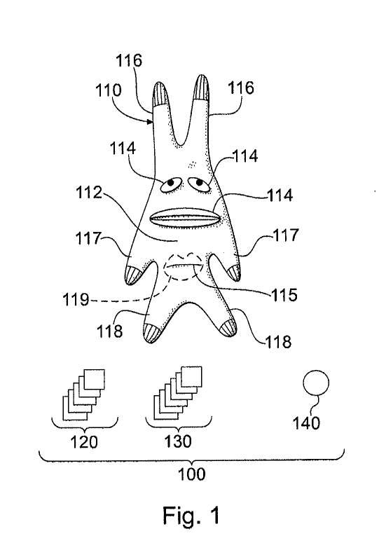

Referring to FIG. 1, a kit 100 is shown in accordance with one exemplary embodiment of the invention. Kit 100 includes a transitional object in the form of a doll referred to as “Cellie” 110. In addition, kit 100 includes module units in the form of a first set of cards 120 containing a first set of indicia. Kit 100 also includes module units in the form of a second set of cards 130 containing a second set of indicia. Finally, kit 100 includes a coping device or tool 140. Cellie 110 provides a communication aid through which a child receives information for coping with stress issues related to cancer diagnosis and treatment.

Where a doll is used as the transitional object, the doll may include one or more areas for storing module units and other accessories in the kit. The areas not only serve a storage function, but also serve as module unit receivers. Specifically, these areas on the doll provide an interactive component that the child can use to receive messages and communicate with the doll. Storage areas may include cavities formed in the doll's body at various locations. In addition, or in the alternative, storage areas may be provided in objects associated with the doll, such as a doll handbag, doll backpack or other accessory. Cellie 110 includes a pocket 115 formed in a belly region. Pocket 115 forms an interior space 119 (the wall of which is shown in phantom lines) that is large enough to hold card sets 120 and 130 and coping tool 140 inside Cellie 110. In this arrangement, pocket 115 functions as a module unit receiver for receiving one or more cards.

First card set 120 includes a collection of cards containing printed information. The printed information conveys coping strategies to the child, including but not limited to evidence-based tips for specific medical stressors, instructions and encouraging thoughts. The printed messages in first card set 120 are written with age-appropriate language suitable for the child's age group. The messages may be written in a style and voice that the child recognizes as coming from Cellie 110. Alternatively, the messages may be written in the form of age-appropriate tips or instructions for interacting with Cellie. Second card set 130 includes a collection of cards containing printed messages directed to parents, caregivers, members of the child's treatment team, and others who assist the child. The messages in second card set 130 include instructions and suggestions for helping the child cope with specific stressful conditions and emotions, such as the fear of getting an injection, or feelings of nausea.

Kits in accordance with the invention may include additional information for individuals other than the child and the child's caregivers. For example, kits in accordance with the invention may include card sets tailored for the child's siblings, classmates at school, teachers, or other individuals who spend time with the child. The card sets may include tips for how to cope with feelings of stress or anxiety that are experienced because of the child's condition as well as tips on how to help the child cope.

The information provided in card sets 120 and 130 are based on cognitive behavioral therapy and clinical experience specific to helping children and their families adjust to and deal with cancer and its treatment. Kit 110 can be used with or without professional guidance from counselors and mental health professionals. Mental health professionals can greatly enhance and personalize tips for each specific child and family. Therefore, kits that use cards preferably include several blank cards which can be filled out by health professionals or others to include additional tips and strategies that are customized for the child. The blank cards can be used to update or supplement card sets 120 and 130 with additional tips that are discovered or learned during the child's treatment, for example.

First and second card set 120 and 130 may include instructions for using different coping aids that come with kit 110, or coping aids that can otherwise be obtained. For example, a card in first card set 120 or second card set 130 may contain instructions that involve the use of coping tool 140. Coping tool 140 is a ball made of polyurethane foam rubber, sometimes referred to as a “stress ball”, that an individual can hold in their hand and squeeze to reduce feelings of anxiety. A variety of toys, gadgets, games or diversions can be provided as coping aids in accordance with the invention, which may be stored inside the doll, or as an accessory on the doll's exterior. For example, kits in accordance with the invention may include books, notebooks, coloring books, chewing gum, portable video games and portable music players.

Cellie 110 is preferably used as the child's constant companion. Body 112 is soft and light-weight so that a child can carry Cellie on their person, and sleep comfortably with Cellie. The portable nature of Cellie 110 encourages children to carry Cellie with them all day, so that kit 100 is always readily available when needed. The portable nature of Cellie 110 also encourages younger children to adopt Cellie as a transitional object that can be carried and held, similar to a security blanket.

Dolls in accordance with the invention may be designed with decorative and ornamental features. Any type of material may be used to make dolls in accordance with the invention, but preferably, the doll is made of a softer material. Dolls may incorporate a number of features resembling body parts. In addition, dolls may include one or more decorative appliqués. The shape, texture, arrangement and color of the doll's body parts, and the shape, texture, arrangement and color of the appliqués are entirely arbitrary, and any design may be used to ornament the doll. Cellie 110 has a soft fabric body 112 containing a number of ornamentations and decorative features. Body 112 contains a number of appliqués 114 that represent facial features. Body 112 also includes extensions representing body extremities, including pointed ears 116, rounded arms 117 and rounded legs 118. The arms 117 and legs 118 are decorated with bright colored fabrics.

A child or child's caregiver can use Cellie in a number of ways to promote positive adjustment to a stressful experience or condition. One method in accordance with the invention includes the steps of identifying a stress symptom and communicating with Cellie to find ways of coping with that stress symptom. For example, the method may include the steps of identifying a stress symptom that is experienced by the child, selecting a card from a set of cards that contains information for coping with the stress symptom, placing the card inside Cellie, and giving Cellie (with the card inside) to the child so the child can retrieve the card. The child may retrieve the card from Cellie and either read the card or give the card to someone else to read. In another example, a child may express a stress symptom to a parent, and the parent may place an appropriate card in Cellie. The parent may then ask the child to ask Cellie for help. The child may go to Cellie for help, retrieve the card from the pocket inside Cellie and read the card to find out how to cope with the stress symptom.

The sets of cards in accordance with the invention may include a variety of instructions, tips, suggestions or encouraging thoughts for coping with stressful experiences. The following examples illustrate exemplary cards for use in a first set of “coping cards” that contain messages directed to children who are suffering stress symptoms associated with cancer diagnosis or treatment:

### Example 1

### Needle Sticks/Port Access/Spinal Taps

Make a plan with your parents and your nurse. Use this plan every time.

Use a hot pack in the spot where you are going to get poked before your poke.

### Example 2

### Needle Sticks/Port Access/Spinal Taps

Find something to distract you:

Squeeze Cellie tight.

Look at Cellie until it is over.

Blow bubbles.

Listen to music (make a playlist only for pokes).

Play video Games.

Talk to your nurse or parent.

### Example 3

### Needle Sticks/Port Access/Spinal Taps

If pokes bother you, ask to be in a quiet place for pokes.

Squeeze a stress ball before you get poked for a blood draw.

My ideas: ______

_______

### Example 4

### Needle Sticks/Port Access/Spinal Taps

Ask your nurse to give Cellie an IV or blood draw.

Ask your nurse to access Cellie's port.

Tell Cellie or write a note and stuff it in Cellie if you are feeling nervous.

### Example 5

I feel scared or nervous.

Talk to Cellie.

Write notes to yourself or to Cellie and stuff it in Cellie's pocket.

My ideas: ______

______

### Example 6

I feel scared or nervous.

Blow bubbles.

Squeeze a stress ball.

Talk to your school counselor.

### Example 7

I feel scared or nervous.

Use belly breathing (breathe in slowly making your belly stick out and then breathe out REALLY slowly).

Talk to your doctor or nurse.

### Example 8

I feel scared or nervous.

Make a MOTTO!

Think of something special to tell yourself to make you feel calmer (example: I am okay).

Write down your special phrase on the “MY MOTTO” coping card.

Tell your parent/friend your motto to help you remember it.

### Example 9

### Motto Card

MY MOTTO IS:

______

______

### Example 10

I don't like blood transfusions.

Ask your doctor any questions that you have about the transfusion.

Watch a movie or talk to a friend or family member during the transfusion.

My ideas: ______

### Example 11

I do not know what will happen at the hospital today.

ASK LOTS OF QUESTIONS!!

Write down the answers and stuff them in Cellie's pocket.

My ideas: ______

______

### Example 12

I do not know what will happen at the hospital today.

Talk to your mom, dad, or another adult who can explain what you will do at the doctor's or hospital.

Talk to your nurse or doctor.

### Example 13

I hate taking medicine.

Get it over with as fast as you can.

Make a plan with your parents about your medicines.

Talk to your mom, dad, or doctor if you have trouble swallowing the pills.

### Example 14

I get sick (throw-up, headache) on the way to see my doctor.

Make a plan with your mom or dad the day before you go to the doctor.

Bring an activity (movie, book, video game, music) to do in the car.

### Example 15

I get sick (throw-up, headache) on the way to see my doctor.

Use Cellie as a pillow to help you relax.

Pack a vomit bag in Cellie.

My ideas: ______

### Example 16

I get sick (throw-up, headache) on the way to see my doctor.

Use belly breathing (breathe in slowly making your belly stick out and then breathe out REALLY slowly) to help stay calm.

Pick foods that do not bother your stomach.

### Example 17

Tummy aches

Decorate a vomit bag or bucket.

Take a nap.

My ideas: ______

### Example 18

Tummy aches

Use belly breathing (breathe in slowly making your belly stick out and then breathe out REALLY slowly).

Blow bubbles.

Tell your mom or dad and doctor.

### Example 19

Tummy aches

Listen to your favorite music.

Do something fun instead of thinking about your belly ache.

Tell yourself that it is okay to feel sick sometimes.

### Example 20

I cannot sleep.

Talk to your parents and make a bedtime routine:

Go to bed at the same time every night and wake up at the same time every morning.

Make a schedule of relaxing activities to do every night before bed (like read a book to Cellie).

### Example 21

I keep thinking about being sick.

Make a picture or write a story about how you feel about being sick.

Find a place to write down your thoughts.

### Example 22

I keep thinking about being sick.

Share your story with a grown-up you trust.

Tell Cellie about it.

My ideas: ______

### Example 23

Staying overnight at the hospital.

Make a plan.

Learn your nurses' names in case you have questions or need anything.

Ask how long you might be staying.

### Example 24

Staying overnight at the hospital.

Find out what will happen when you stay in the hospital.

Ask your parents if you can have any visitors.

My ideas: ______

### Example 25

Staying overnight at the hospital.

Take Cellie with you to use as a pillow or to pack special things in.

Pack fun games, movies, and other activities.

### Example 26

### Missing School

Some hospitals have teachers who can come to your room when you are in the hospital and help you with school work. Ask if you can see a teacher.

### Example 27

I feel sad.

Sometimes it is okay to cry.

Talk to your parent or a special adult to help you try to feel better.

### Example 28

### Missing School

Have your parents talk to your teacher and find out about how to make up your class work.

My ideas: ______

### Example 29

I feel sad.

Ask someone to play your favorite game or watch your favorite movie with you.

Ask for hugs.

### Example 30

I feel sad.

Give Cellie a big hug.

Tell Cellie that you feel bad.

My ideas: ______

### Example 31

Everyone keeps asking me how I feel and I don't want to talk about it.

Ask your mom or dad to tell people to stop asking you that.

Tell the people that you don't want to talk about it.

### Example 32

Everyone keeps asking me how I feel and I don't want to talk about it.
Tell people about other things (besides cancer) that you are doing:
   Example: playing with your friends or taking a trip

### Example 33

Chemo takes forever and I am BORED.

Pack a bag of things the night before.

Ask your nurse if they have any special activities to do at the hospital.

### Example 34

Chemo takes forever and I am BORED.

Take a friend with you.

Make a new music playlist to listen to.

My ideas: ______

### Example 35

My hair is falling out.

Have a head shaving party with any friends or family members who are interested.

Tell your parents you are worried.

### Example 36

My hair is falling out.

Find a new hat, scarf, bandana, or wig.

Buy a matching hat/bandana for Cellie.

My ideas: ______

### Example 37

My hair is falling out.

Ask your best friend what he/she thinks about you losing your hair.

Find pictures of people who are bald or have short hair and make a collage.

Remember, “Bald is beautiful!”

Each of the examples above may be a separate module unit in the form of a card with printed information.

The following examples illustrate exemplary cards for use in a second set of “coping cards” that contain messages directed to parents or caregivers who assist children suffering stress symptoms associated with cancer diagnosis or treatment:

### Example 38

### INTRODUCTION TO CELLIE

Most children, teens, and parents are able to adapt to the cancer diagnosis and treatment well. However, we know that cancer, treatments and side effects from treatment can be challenging.

We have developed “Cellie” and Cancer Coping Cards (CCC) to provide kids and parents with tips that can be helpful as your family navigates through the cancer experience.

Parents are key in helping their children cope with stressful situations; thus, we have developed some CCC with tips for parents to help their child cope.

### Example 39

My child becomes nervous any time we discuss cancer, treatment, or going to the hospital/doctor.

Discuss your child's fears with his/her doctor.

Provide your child with age-appropriate information about what to expect at each doctor's appointment or hospital visit.

Support your child's reactions (e.g., “this can be scary”) and try to understand what exactly is causing the fear.

Avoid telling your child that there is no reason to be afraid or that a procedure will not hurt.

### Example 40

### INTRODUCTION TO CELLIE

We recommend that you review your children's coping cards and help your child choose ones that are related to their specific cancer experience.

The tips are based in research and our experiences working with children with cancer and their families.

These tips are not a replacement for professional help. If you are worried about your child's reactions or your family's reactions to cancer, talk to your doctor.

### Example 41

My child becomes nervous any time we discuss cancer, treatment, or going to the hospital/doctor.

Make a plan for the day and write it out with your child so he or she remembers what to expect.

Have your child take the plan and keep it in Cellie's pocket in case he/she forgets.

Help your child identify and select relaxing activities (reading, music, artwork, TV).

Learn diaphragmatic breathing and teach it to your child (“belly breathing”).

### Example 42

My child becomes nervous any time we discuss cancer, treatment, or going to the hospital/doctor.

Listen to your child.

Let your child vent when they need to.

Help your child to develop a calming statement (i.e., motto) that he or she can use when feeling nervous (e.g., “I'm okay today.”).

Develop a family motto for coping with cancer.

### Example 43

My child gets bored at the hospital.

Pack a bag of activities to do the night before.

Occasionally, surprise your child with a new activity (game/music) at a long doctor's appointment.

Ask your child's nurse or child life specialist if they have any special activities to do at the hospital.

Start an art project that your child ONLY works on at the hospital.

### Example 44

My child gets sick (feels nauseous, vomits, has headaches) on the way to see my doctor or to the hospital.

Make a plan with your child for the day before you go to the doctor or hospital.

Pick foods for your child to eat before the appointment that are easier to digest.

Keep the car ride as stress-free as possible.

Allow your child to nap in the car on the way to the appointment.

### Example 45

My child gets sick (feels nauseous, vomits, has headaches) on the way to see my doctor or to the hospital.

Bring Cellie in the car ride for your child to use as a pillow or fill Cellie's pocket with games or toys to distract your child.

Encourage your child to keep his or her body relaxed.

Help your child use diaphragmatic breathing.

### Example 46

My child gets sick (feels nauseous, vomits, has headaches) on the way to see my doctor or to the hospital.

React calmly if your child is not feeling well or vomits.

Bring a bag or bucket in case your child needs to vomit.

Decorate the bag/bucket.

Remind your child that it is okay to get sick.

### Example 47

I don't know how much information to share with my child about his/her treatment and diagnosis.

Ask your medical team if you are unsure about sharing specific information.

Be honest with your child and provide age-appropriate information.

Children should be told the name of their illness (they will otherwise overhear it!) and the basic information about what to expect (e.g., you will go to the hospital to get checked, you will take some medicines).

### Example 48

I don't know how much information to share with my child about his/her treatment and diagnosis.

Encourage your child to ask questions.

Some hospitals have child life specialists who can help provide age-appropriate information to your child about treatment and specific procedures.

Use Cellie, explaining that Cellie is a healthy cell and that the doctors are trying to make the cells healthy.

### Example 49

Ideas for your child's needle sticks/port access/spinal taps:

Get your child a hot pack before his/her procedure to put on the spot where he/she is going to get poked.

For a blood draw, encourage your child to squeeze a stress ball before they get poked to get their blood flowing.

Bring something for distraction (music, movie).

Learn diaphragmatic breathing and teach your child.

### Example 50

Ideas for your child's needle sticks/port access/spinal taps:

Have your child squeeze or look at Cellie until the procedure is over.

If your child struggles with needle sticks/port access/spinal taps, work with his/her nurse to develop a consistent plan for how the procedure will be completed.

Ask to be in a quiet place.

### Example 51

My child talks about or thinks about cancer constantly.

Consult with your child's physician and school counselor.

Keep your child's routines during treatment as close as possible to routines prior to diagnosis.

Allow your child to talk to you about his/her cancer but also encourage discussions about other topics (e.g., playing with friends, favorite TV shows, vacations).

### Example 52

My child talks about or thinks about cancer constantly.

Help your child find a way to express his/her thoughts and feelings about cancer:

Draw or paint a picture.

Write a story about how you feel about being sick.

Share the story with Cellie or talk to Cellie about it.

Yell at Cellie if they are angry.

Make a “cancer playlist.”

### Example 53

I have a difficult time getting my child to take his/her medicines.

Have the child's doctor or nurse explain what each medication is for.

Talk to your child's doctor if your child refuses medications, has trouble swallowing the pills, or vomits after taking his or her medications.

Check with your doctor or pharmacist to see if the medication comes in a different delivery mode (e.g., liquid, pills).

Allow plenty of time to administer medications (i.e., avoid trying to have your child take the medications when you are in a hurry to do is something).

### Example 54

I have a difficult time getting my child to take his/her medicines.

Have your child give Cellie medicines every day (e.g. vitamins) under your supervision.

Set up a plan (with rewards) for your child to follow in taking his or her medicines.

Use a sticker/star chart for taking medicines.

Make a treasure chest (have your child decorate it) with cheap prizes to earn for taking medications.

### Example 55

My child is missing a lot of school.

Talk to your child's teacher/principal and find out about how they can stay caught up with schoolwork.

If your child is in the hospital, some hospitals have teachers who can come to your child's room to help him/her with school work.

Talk to a social worker or doctor if your child is having trouble at school so they can get your child extra help.

If necessary, work with the school to set up an IEP or 504 plan to provide an individualized education plan for your child.

### Example 56

My child cannot sleep.

Set a bedtime routine for your child:

Set the same bedtime every night and same waking time every morning.

Perform routine activities in the same way each night (e.g., brushing teeth, reading a book)

Have your child read Cellie a book at night.

Turn the TV off before your child falls asleep.

Have a quiet activity ready if your child wakes up and can't fall back asleep (books, coloring books).

Tell your child's doctor about sleep challenges.

Help your child use diaphragmatic breathing each night.

### Example 57

My child has frequent nausea.

Tell your child's doctor.

Try to minimize stress during periods in which your child is likely to feel nauseous.

Use distraction.

Carry a vomit bag or bucket.

React calmly and explain to your child that it is probably because of the medicine(s).

Have your child use deep breathing.

Encourage your child to participate in fun, “normal” activities.

### Example 58

My child becomes sad when thinking about cancer or cancer treatment.

Let your child's doctor know.

Consider speaking with your child's school counselor.

Keep your child involved in family or friend activities.

### Example 59

My child's hair is falling out.

Organize a head shaving party with family members or friends that are willing.

Find fun hats or scarves for your child.

Find a matching hat or scarf for Cellie.

Help your child find pictures of people who are bald or who have short hair. Have your child make a collage or describe the traits of the people in the pictures.

### Example 60

My child is restricted to staying at home or in the hospital and doesn't get to see his/her friends.

Hang up pictures of your child's friends in his or her room at home or in the hospital room.

Hang up cards or pictures from other children in your child's room.

Encourage your child to stay in touch with friends and family members.

Encourage your child to call a friend to talk on the phone.

### Example 61

Everyone keeps talking to my child and me about his or her cancer and treatment.

Make an online care page where you can post information about your child's treatment and your experiences.

If your child does not want to discuss his/her cancer with other people, tell people to please direct questions to you.

Share other family news with interested friends/family so that the focus is not limited to your child's health.

### Example 62

Motto card

FAMILY MOTTO FOR COPING WITH CANCER:

______

### Example 63

### Diaphragmatic Breathing Tips:

Breathe in slowly (for about 4 seconds).

Take the air all the way in to expand your stomach.

Breathe out slowly (for about 5 seconds).

*Breathe out longer than you breathe in*

If you or your child feels dizzy, stop and ask your doctor for more instructions.

Each of the examples above may be a separate module unit in the form of a card with printed information.

Thus far, examples of kits and methods have been described with printed cards that convey information to children and caregivers. Printed cards have been found to provide a cost-effective way to manage, organize and store coping tips. Nevertheless, coping information for children may be stored and delivered using a variety of different media, and need not be in the form of printed cards. Dolls like Cellie 110 function as an interface that the child can use to receive coping information, and the media used to convey the coping information is not critical. Therefore, dolls in accordance with the invention may be designed to work with storage media in addition to printed cards, or as an alternative to printed cards. For example, dolls like Cellie 110 may be manufactured with one or more audio recording playback devices that can deliver coping information to children through audio recordings. Audio recording playback devices that can be used in accordance with the invention include but are not limited to cassette tape players, compact disc players, or digital audio players (e.g. MP3 players).

Coping information for adult caregivers may also be contained in a variety of different media, and need not be contained in printed cards. For example, coping tips and instructions for adults may be contained in a book or pamphlet that the adult keeps with them when attending to the child.

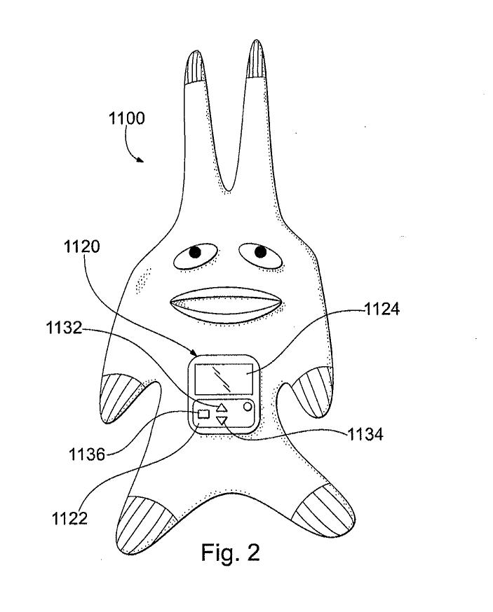

Referring now to FIG. 2, a kit 1100 is shown in accordance with another embodiment of the invention. Kit 1100 includes a transitional object in the form of a doll 1110. Doll 1110 includes a digital audio player 1120 with internal memory that stores a number of module units in the form of audio files. Digital audio player 1120 contains a user interface 1122 and a display screen 1124. Each audio file contains a voice recording with a unique message directed to a child for coping with a specific stressor or experience. Display screen 1124 is adapted to display each audio file and a brief description of its content. Each message is stored in a separate audio file that can be indexed and selected on display screen 1124 using interface 1122. Interface 1122 is shown with a power button 1130, two navigation buttons 1132 and 1134, and an enter button 1136. Power button 1130 is connected to a switch that connects user interface 1122 and display screen 1124 to a power source, such as a battery pack inside Cellie 1100. Navigation buttons 1132 and 1134 are operable to move a cursor or scrolling function on display screen 1124, allowing a user to find an audio file from a list of audio files on the display screen. Enter button 1136 is operable to select a specific audio file for playback. Any user interface configuration may be used in accordance with the invention, including but not limited to buttons on the user interface, touch screen features separate from the display screen, and/or touch screen features on the display screen.

Module units stored in the doll's internal memory unit may not address every possible stress symptom, or may not be appropriate for every patient. Therefore, it may be desirable to supplement the module units that are stored in the doll's internal memory unit with other module units. For this reason, kit 1110 includes a plurality of cartridges 1150 that contain additional module units not stored in the doll's internal memory unit. Each cartridge 1150 stores a module unit in the form of an audio file. Each audio file contains a recorded message conveying an instruction for coping with a stress symptom. Doll 1110 includes a module unit receiver in the form of a cartridge slot 1140 located on the doll's front side. To play back a module unit stored on a cartridge 1150, the power button 1130 is pressed to turn on the digital audio player 1120. Then, the cartridge 1150 with the appropriate module unit is selected and inserted into the cartridge slot 1140. The enter button 1136 is then pressed to play back the recorded message stored on the cartridge 1150.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the scope of the invention.

What is claimed:

1. A kit for use in promoting a patient's positive adjustment comprising:
a plurality of module units, each module unit containing an instruction for coping with a specific stress symptom; and centre, a transitional object having a module unit receiver for receiving one of the module units and delivering the instruction on the module unit to the patient.

2. The kit of claim 1, wherein the plurality of module units comprises a plurality of cards with printed indicia, and the module unit receiver comprises a cavity to inside the transitional object adapted to physically store one or more of the cards.

3. The kit of claim 1, wherein the plurality of module units comprises a plurality of electronic storage media, each electronic storage medium comprising a transmitter for transmitting an instruction to the module unit receiver, the module unit receiver comprising a receiving device for reading the instruction transmitted by the is electronic storage medium.

4. The kit of claim 3, wherein the transitional object further comprises a digital audio playback device.

5. The kit of claim 3, wherein the transitional object further comprises an electronic user interface and display screen.

6. The kit of claim 3, wherein the plurality of electronic storage media comprise a plurality of cartridges, and the receiving device comprises a cartridge slot.

7. The kit of claim 6, wherein the coping tool is sized to be stored inside the transitional object.

8. A method of promoting positive adjustment comprising the steps of:
providing a patient with a transitional object and a plurality of module units, each module unit containing an instruction for coping with a specific stress symptom;
identifying a stress symptom that is experienced by the patient;
selecting a module unit having an instruction for coping with the identified stress symptom;
inserting the selected module unit in the transitional object; and
delivering the instruction on the selected module unit to the patient with the transitional object.

9. The method of claim 8 wherein the step of inserting the module unit in the transitional object comprises the step of physically placing the module unit inside a cavity in the transitional object.

10. The method of claim 8 wherein the step of inserting the selected module unit in the transitional object comprises the step of inserting an electronic storage medium into a slot in the transitional object.

11. The method of claim 8, wherein each module unit comprises a card.

12. The method of claim 11, wherein the step of delivering the instruction on the selected module unit to the patient comprises giving the transitional object with is the card to the patient.

13. The method of claim 8, wherein each module unit is stored on an electronic storage medium.

14. The method of claim 13, wherein the step of delivering the instruction on the selected module unit to the patient comprises inserting an electronic storage medium into the transitional object and playing back an audio recording.

15. The method of claim 8 further comprising the step of selecting a module unit having an instruction for a caregiver for helping the patient cope with a stress symptom.
